(19) United States
(12) Patent Application Publication
(10) Pub. No.: US 2026/0160953 A1
(43) Pub. Date: Jun. 11, 2026

(54) Vertically Interconnected PIC Stack (VIPS) and Method of Manufacturing Same

(71) Applicant: Phase Sensitive Innovations, Inc., Newark, DE (US)

(72) Inventors: Peng Yao, Newark, DE (US); Janusz Murakowski, Bear, DE (US); Shouyuan Shi, Newark, DE (US); Dennis Prather, Newark, DE (US)

(21) Appl. No.: 19/415,727

(22) Filed: Dec. 10, 2025

Related U.S. Application Data
(60) Provisional application No. 63/730,047, filed on Dec. 10, 2024.

(51) Int. Cl. G02B 6/34

(52) U.S. Cl. CPC G02B 6/34

(57) ABSTRACT

A Vertically Interconnected PIC Stack (VIPS) provides high-density optical interconnections between stacked photonic integrated circuits (PICs). The stacked PICs are optically interconnected through optical connections formed in photonic via ports defined by an opening in a PIC or aligned openings in several of the PICs. The PICs can be implemented on different material platforms (e.g., Si, InP, or thin film lithium niobate (TFLN)) to support different functions. The process allows for continuous stacking and vertical optical connections between multiple PICs. The resulting VIPS provides a large amount of optical connections between PICs within a compact form factor.

### CROSS-REFERENCE TO RELATED APPLICATION

This application claims priority to U.S. Provisional Patent Application No. 63/730,047 filed Dec. 10, 2024, the disclosure of which is hereby incorporated by reference in its entirety.

### BACKGROUND

The field of the invention relates generally to Photonic Integrated Circuit (PIC) technology and methods for optically interconnecting and packaging multiple PICs. PICs are typically connected to each other mainly through coupling to PIC inputs at the edge of the PIC. Edge lengths of the PICs restricts the total possible number of interconnections as well as creating design constraints of the PIC.

### SUMMARY

Embodiments disclosed herein the vertical integration of photonic integrated circuit (PIC) chips (e.g., in a package) and methods for manufacturing the same. A vertically integrated PIC stack (VIPS) may provide high-density optical interconnections between stacked PICs. The PICs can be implemented with different material platforms, e.g., Si, InP or thin film lithium niobate (TFLN), provide different functionalities, and may operate at different optical wavelengths and RF frequencies. Electronic integrated circuits (e.g., using conventional CMOS designs) may also be combined in the packages.

Vertical optical interconnections between the PICs can be made through photonic via ports that are micromachined during or post-PIC chip fabrication, and/or at the peripheral edges of the chips. The use of photonic via ports increases the number of inter-chip optical connections and is not constrained by the chip edge length. The vertical optical interconnections between the PICs may be formed through the photonic via ports using polymer waveguides such as photonic wire bonds (PWBs) connecting optical couplers of the PICs.

### BRIEF DESCRIPTION OF THE DRAWINGS

The present disclosure will now be described more fully with reference to the accompanying drawings, in which various embodiments are shown. Like numbers refer to like elements throughout the drawings, which include the following:

FIG. 1 depicts a chip stack 100 of three photonic integrated circuits PIC1, PIC2 and PIC3, vertically stacked and interconnected using polymer waveguides;

FIGS. 2A, 2B and 2C illustrate examples of different optical inter-chip connections between two PICs within a photonic via port;

FIG. 3 depicts an exemplary method of manufacturing a chip stack of PICs according to an embodiment; and

FIG. 4 is an enlarged view of the right side of FIG. 1.

### DETAILED DESCRIPTION OF THE EMBODIMENTS

The present disclosure now will be described more fully hereinafter with reference to the accompanying drawings, in which various embodiments are shown. The invention may, however, be embodied in many different forms and should not be construed as limited to the example embodiments set forth herein. These example embodiments are just that—examples—and many implementations and variations are possible that do not require the specific details described herein. It should also be emphasized that the disclosure provides details of alternative examples, but such listing of alternatives is not exhaustive. Furthermore, any consistency of detail between various examples should not be interpreted as requiring such detail—it is impracticable to list every possible variation

for every feature described herein. The language of the claims should be referenced in determining the requirements of the invention.

It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, or as “contacting” or “in contact with” another element (or using any form of the word “contact”), there are no intervening elements present at the point of contact. As the state of contact is binary (either in contact or not in contact), it will be appreciated that “contact” has the same scope as any use of “direct contact.”

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be referenced elsewhere without an ordinal number or with a different ordinal number (e.g., “second” in the specification or another claim). Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

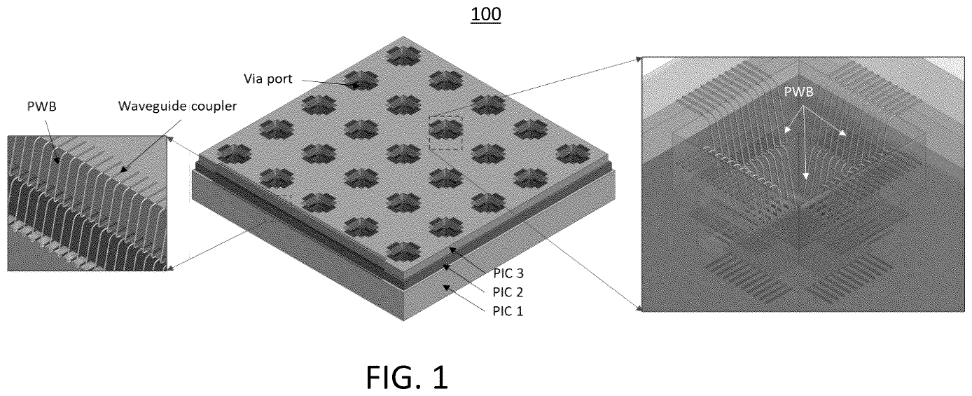

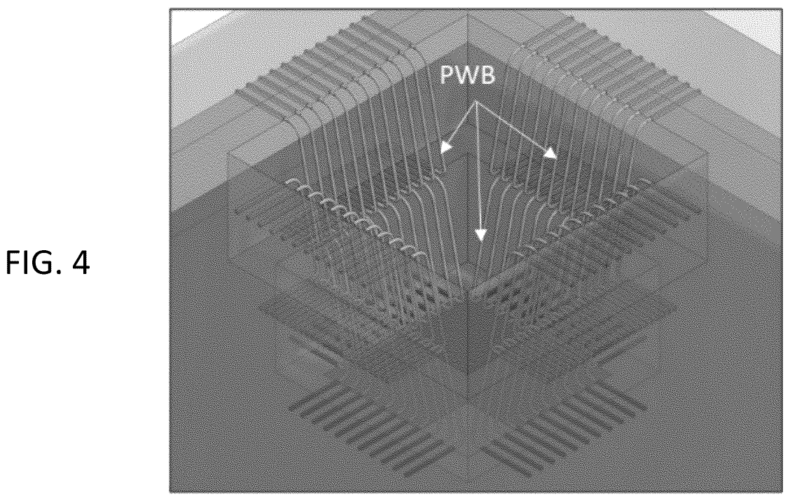

FIG. 1 depicts a chip stack 100 of three photonic integrated circuits PIC1, PIC2 and PIC3, vertically stacked and interconnected using polymer waveguides. A PIC refers to an optical circuit fabricated on a single continuous substrate. Each PIC is an optical chip (or photonic chip) that utilizes photons to process and carry information. These chips are similar to semiconductor chips that process information electronically in being monolithic and cut from a wafer, except that they integrate multiple photonic components (like lasers, modulators, waveguides, and detectors) with a single substrate. PICs need not be limited to photonic components and may include electronic components as well. Some PICs also include conventional CMOS semiconductor circuits formed by the interconnection of transistors (e.g., interconnected logic gates formed by semiconductor transistors). The center portion of FIG. 1 is a perspective view of the chip stack 100 (the vertically stacked PICs PIC1, PIC2 ad PIC3) having a plurality of photonic via ports formed therein, the left portion of FIG. 1 is an enlargement of an edge of the chip stack 100 and the right portion of FIG. 1 is an enlargement of a photonic via port of the chip stack 100. FIG. 4 is an enlarged version of the right portion of FIG. 1.

The PICs of the chip stack 100 may be formed on different material platforms, such as Si, InP, SOI, SiN, SiO₂, TFLN, etc., to provide different functionalities, and may operate at different optical wavelengths and/or RF frequencies. For example, PIC3 may be implemented with an InP platform to form lasers, amplifiers and/or photodetectors (part of its PIC), while another PIC2 may be formed with TFLN to form electro-optic modulators to modulate an optical carrier (e.g., a laser beam provided by PIC3) with an RF electrical signal to generate a modulated optical signal (an upconverted signal) containing information of the RF signal. PIC1 may be formed on an SOI platform to simultaneously process several of such RF signals such as with with optical filters, interference spaces (or Fourier transform spaces), such as those formed by a star coupler, to spatially separate different optical beams containing information of different RF signals. Each optical beam may be captured and down-converted to an RF electrical signal, such as by the photodetectors formed on the PIC1 or by a fourth chip of the chip stack 100, such as an EIC (e.g., a conventional integrated circuit chip formed with conventional CMOS semiconductor manufacturing technology).

Each PIC platform may have a different base substrate (e.g., an initial blank substrate, e.g., a wafer) that is processed during the manufacturing of the PIC. During the manufacturing of the PIC, the base substrate may be patterned itself (e.g., selectively etched) and/or additional layers may be formed thereon and patterned in accordance with conventional PIC and/or semiconductor manufacturing technologies. Each base substrate may form the base of the wafer in the final wafer product that includes multiple identical PIC devices that are then separated (singulated or cut from the wafer) to form individual identical PICS. For example, several identical versions of PIC1 may be cut from a first final wafer product having a SOI base substrate of SOI, several identical versions of PIC2 may be cut from a second final wafer product having a TFLN (Thin-Film Lithium Niobate) base substrate, and several identical versions of PIC3 may be cut from a third final wafer product having a base substrate of InP.

The base substrates corresponding to the PIC platforms may be bulk semiconductor substrates or multi-layer substrates. Bulk semiconductor substrates may be formed solely of a crystalline semiconductor material, such as crystalline Si (Silicon), InP (Indium Phosphide), SiC (Silicon Carbide), GaN (Gallium Nitride) or Al₂O₃ (Sapphire). Bulk semiconductor substrates may also be formed of a non-crystalline material, such as SiO₂ (fused silica). A multi-layer base substrate of a PIC platforms may be a silicon on insulator (SOI) substrate (e.g., Si/SiO₂/Si), a Silicon Nitride base substrate (e.g., Si/SiO₂/Si₃N₄) or a TFLN base substrate (Si/SiO₂/LiNbO₃). In these latter multi-layer base substrate examples, the lowermost Si layer may act as a handle substrate (a mechanical support), the SiO₂ may serve as a lower optical cladding layer for an optical waveguide, and the upper layer may form a core of the optical waveguide (e.g., after patterning the upper layer by selective etching using a conventional photolithography or e-beam lithography process).

The layers of the PICs extend horizontally (e.g., have a minimum width in the vertical direction). Patterning of one or more of such layers may form components that extend horizontally, e.g., having a path and/or major dimensions in the horizontal direction, that transmit signals in the horizontal direction. These components may be described as “in-plane” to refer to their vertical confinement (or substantial portions thereof) (e.g., they extend along the horizontal plane). For example, a patterned layer of a PIC may form optical waveguides that extend horizontally and transmit light in a horizontal direction. Patterned conductive layers of the PICs may form RF transmission lines that extend in the horizontal direction and transmit RF electrical signals in a horizontal direction. Antennas may be formed of patterned metal that have arms extending in the horizontal direction. Although such components also include a vertical dimension (e.g., a thickness), such components may have horizontal dimensions significantly greater than the thickness of these components (e.g., horizontal dimensions 1, 2 or more than 3 magnitudes greater than the thickness). For example, an optical waveguide core may be patterned from a layer of a PIC and may horizontally extend in a linear, serpentine, and/or folding manner and have a path length greater than 100× or greater than 1000× of the thickness of its core (e.g., the layer thickness in the vertical direction). In a similar manner, an RF waveguide may be patterned from a metal layer of a PIC and horizontally extend and have a path length greater than 100× or greater than 1000× of its thickness (e.g., the layer thickness in the vertical direction).

The chip stack 100 may also include conventional semiconductor chips comprising electronic integrated circuits (EICs) formed with conventional CMOS semiconductor manufacturing techniques. The conventional semiconductor chips include interconnected transistors interconnected to form the EICs. The base substrate of such semiconductor chips may be formed of or include crystalline semiconductor material, such as bulk Si, bulk SiGe, SOI, etc. It should be appreciated that such conventional semiconductor chips may also include photonic devices (e.g. photodetectors/photodiodes, a laser diode, etc.). However, such conventional semiconductor chips typically do not include any optical couplers to input optical signals. More specifically, conventional semiconductor chips typically do not include any optical couplers to physically connect to optical waveguides to input optical signals, such as optical data signals (e.g., in contrast to image sensor ICs—that may be formed as a conventional semiconductor chip—that obtain an image by sensing external light input to the image sensor IC, but such light is not input through an optical connector of the image sensor IC that is physically connected to an optical waveguide). Conventional semiconductor chips instead communicate externally via electrical signals (e.g., through chip pads that connect to other chips using external conductive wiring connected to the chip pads). The term “semiconductor chip” may be used to refer to such conventional EICs although it will be appreciated that PICs may also include semiconductor material and electronic circuits

Each of the chips may be vertically stacked on one another during manufacturing. It should be appreciated that the vertical orientation of the stack need not be maintained in the final product. For ease of description, directional terms and/or spatially relative terms, such as “vertical,” “horizontal,” “beneath,” “below,” “lower,” “above,” “upper,” “top,” “bottom,” “front,” “rear,” and the like, may be used herein to describe positional relationships, such as illustrated in the figures and/or that exist during manufacturing. Thus, it will be understood that the spatially relative terms encompass different orientations of the device in addition to the orientation depicted in the figures. In some instances, the VIPS chip stack 100 may be rotated sideways in the final product where the chip stack 100 is attached to a package substrate with the horizontal surfaces of PICs being perpendicular to the surface of the package substrate (e.g., like books arranged on a bookshelf).

VIPS may provide a large channel count within a given area and while providing a compact form. As shown in FIG. 1, photonic wire bonds (PWB) optically interconnect different PICs of the chip stack 100. It will be appreciated that the photonic wire bonds are not actually conductive wires. Rather, each photonic wire bond PWB forms the core of an optical waveguide and provides an optical path (and optical communication) between the PICs to which it is connected. The name “photonic wire bond” denotes the similar function and appearance of the PWBs to conductive wire bonds used in conventional semiconductor chip manufacturing for electronic integrated circuits (EICs). As shown in FIG. 1, the PWBs similarly extend between different PICs (or may extend between a PIC and an optical fiber or optical fiber coupler to which an optical fiber is attached) to provide similar communications to the PICs, but provided optically rather than electrically.

As shown on the left of FIG. 1, the PWBs extend between optical couplers at the edges of the PICs (e.g., at outer periphery of the PICs with respect to a top down view). For illustration purposes, only one edge of the chip stack 100 is shown to include PWB connections between the PICs, but such PWB connections may be formed between the PICs at several (e.g., all four) sides of the chip stack. Furthermore, PWB connections at an edge of the chip stack 100 may be between all or only some of the chips of the chip stack 100.

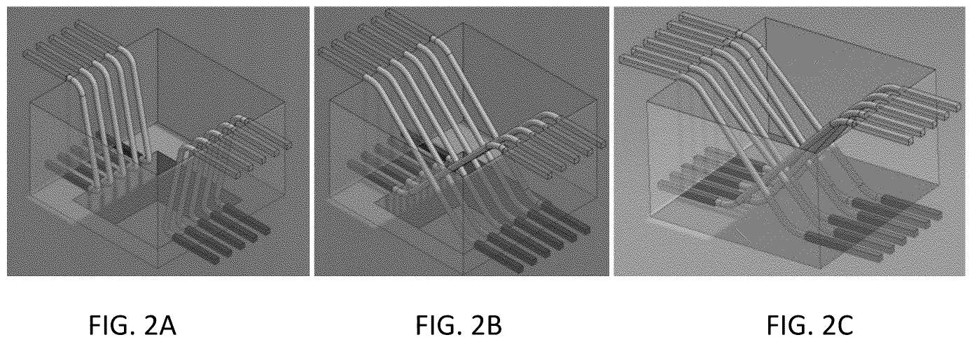

Photonic via ports in the chip stack 100 also provide additional PWB connections between the chips of the chip stack. The right side of FIG. 1 is an enlarged view of one of these photonic via ports showing exemplary PWB connections. FIGS. 2A, 2B and 2C show photonic via ports with different PWB connections. It should be appreciated that each of these PWB connection examples (right side of FIG. 1 and FIGS. 2A, 2B and 2C) may be implemented with a photonic via port of the chip stack 100, together with the other PWB connection examples or implemented in the alternative.

Each photonic wire bond (PWB) is a 3D polymer waveguide that interconnects pairs of the PICs (via corresponding optical couplers of the PICs) to communicate an optical signal and provide optical communication between the thus connected PICs. The optical signal may include information (e.g., data) and/or form part of a larger set of optical signals that are being processed to extract various types of information (e.g., extract encoded data). In some examples, optical processing may simultaneously process multiple channels of optical signals in parallel. Each channel may comprise a plurality of optical signals (e.g., 24, 64, 200, etc.) with each optical signal of a channel being transmitted by a corresponding optical path formed by several interconnected optical waveguides. Each PWB may form part of one of such optical paths, acting as an optical bridge to connect a corresponding pair of optical waveguides in the connected PICs. While not limited to such processing, the VIPS disclosed herein may facilitate a more compact form factor for processing optical channels in parallel.

The PWBs may be formed by a 3D printing technique. For example, the PWBs may be formed of a photosensitive polymer resist and be fabricated by 3D Direct Laser Writing (DLW). The 3D printing may be performed by two-photon DLW or one-photon DLW, however other 3D printing techniques may be used, such as stereolithography.

During formation of a PWB, the PICs to be connected to a PWB are covered in (e.g., immersed in a bath) a photosensitive liquid polymer resist (e.g., a negative-tone resist) that covers the optical couplers to be interconnected by the PWB. A laser is focused at a selected portion of the resist to cause polymerization of the liquid resist (cross-linking of monomers or oligomers of the resist) at the laser focal point such that the liquid resist is converted to a solid at the focal point (due to the high intensity of the laser at its focal point). The focal point of the laser is moved (e.g. stepped) to adjacent locations within the liquid resist to continue solidifying the resist at the selected confined locations (corresponding to the focal point of the laser) to construct the PWBs. For example, moving the focal point of the laser through the liquid resist along a path between two optical connectors (of two different PICs) results in solid tube of polymer being formed along that path, this solid tube of polymer forming the PWB that forms a core of the PWB optical waveguide. It will be understood that an optical waveguide is formed of a core and a cladding material surrounding the core, but that an optical waveguide is often referenced with respect to its core (as this is the portion that contains the light that is transmitted by the optical waveguide). Such terminology may also be adopted herein when generally referring to an optical waveguide, with the use of “core” and “cladding” to specify more details of an optical waveguide.

The liquid photosensitive resist may comprise an epoxy resin (an epoxy polymer in its uncured state (e.g., short-chain polymers, oligomers), photoacid generators (PAG) and a solvent. The PWBs may be formed of a solidified epoxy resin, e.g., a solidified epoxy polymer resulting from cross-linking of the uncured epoxy resin polymer (oligomers or monomers) of the liquid photoresist (after the uncured epoxy resin polymer is decomposed by acid released by the PAG (which is caused by the exposure to the high intensity laser at its focal point)).

After forming the PWBs, the unexposed (non-solidified) liquid resist is removed by with a chemical developer, leaving the solidified, free-standing polymer waveguide cores (the PWBs). A low refractive-index polymer (lower than the refractive index of the material forming the PWBs) or a protective material may be applied around and encapsulate the PWBs and act as a final cladding layer for the PWB optical waveguides as well as provide structural integrity. Optionally, no final cladding layer may be applied and air or other gas may be used as cladding (air cladding).

Edge couplers and/or surface couplers may be used to connect the PWB optical waveguide to optical waveguides integrated within the PICs. Edge couplers formed withing a PIC (e.g., butt couplers or in-plane couplers) may comprise a tapered portion of the waveguide core, extending from the remainder of the waveguide core and narrowing towards the edge of the PIC where it terminates (forming part of the edge of the PIC and may be coplanar with the other portions of the edge of the PIC). When a PWB is coupled to a PIC with an edge coupler, the PWB is formed to contact the edge of the PIC and more particularly, the face of the edge coupler at the edge of the PIC. The optical axis of the PWB is aligned with that of the edge coupler formed in the PIC and results in the PWB axis at the edge of the PIC being aligned horizontally and parallel with the material layer forming the edge coupler and in-plane waveguides of the PIC.

Surface couplers (e.g., grating couplers) may also be used to couple light between the PWB optical waveguide and the PIC waveguide. A diffractive grating is etched into the top layer of the PIC and the PWB terminates (as an end) at the diffractive grating. Light emitted from the end of PWB waveguide (which may be at an oblique angle with respect to the PIC surface) is diffracted by the grating to be coupled into the waveguide of the PIC.

FIGS. 2A, 2B and 2C illustrate examples of different optical inter-chip connections between two PICs within a photonic via port. In FIG. 2A, a photonic via port is defined by an opening in a bottom PIC and an opening in the top PIC aligned with the bottom PIC. FIG. 2A illustrates the optical interconnections formed with edge to edge connections (using edge couplers) and the PWBs having a “C” shape resulting in the optical path remaining on the same side of the photonic via port. FIG. 2B has a similar configuration as that of FIG. 2A to connect the PICs using edge connections (and edge couplers), except that the PWBs have an “S” shape to provide an optical path that extends across the photonic via port (between opposite sides of the walls defining the photonic via port). FIG. 2C differs from the example of FIG. 2B by connecting the PWBs to the bottom chip with surface couplers. As such, there is no need to provide an opening in the bottom PIC and the photonic via port is defined by solely by the opening in the upper PIC in this example. It will be appreciated that one or more additional PICs may be stacked on the PICs shown in FIGS. 2A, 2B and 2C may have openings formed therein to align with the photonic via port shown in FIGS. 2A, 2B and 2C and thus extend the photonic via port through these additional chip(s).

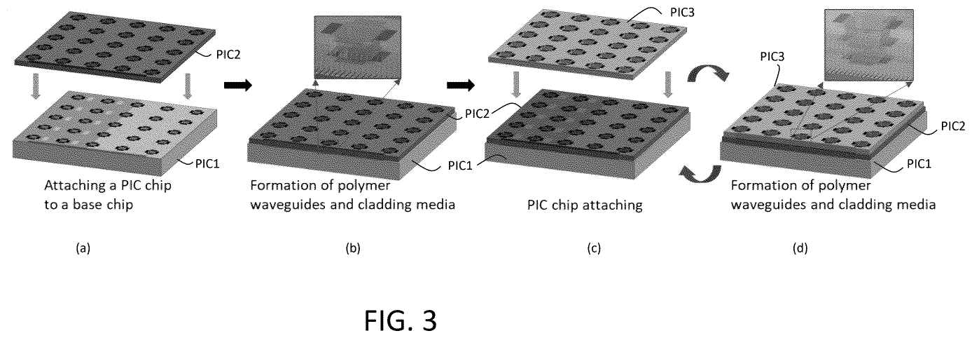

FIG. 3 depicts an exemplary method of manufacturing a chip stack of PICs according to an embodiment. In step (a), PIC2 is attached to PIC1 with an adhesive (e.g., epoxy) or other conventional attachments. The chip placement of PIC2 can be performed using conventional techniques and assisted by self-alignment patterns (not shown) formed in the top surfaces of the PICs. Alignment of the PICs need not be extremely precise as the stacking need not align optical couplers of the PICs so that they contact/connect to one another. To assist later connections to optical surface couplers at edges of the PICs, the edges of PIC2 may not align with the edges of PIC1 so that a portion of the upper surface of PIC1 is exposed (i.e., not covered by PIC2) and such exposed portion of PIC1 may include optical surface couplers. From a top down perspective, the PICs may have the same size and shape (e.g., same footprint area) or may have different sizes and shapes. In some example, identical PICs (having the same size, shape and circuits) may be included in the chip stack 100.

Prior to attaching the PICS to one another, photonic via port openings (holes) may be formed in each of the PICs. The photonic via port openings may be micromachined, such as by deep reactive ion etching or laser ablation. When the PICs are stacked in the chip stack 100, corresponding photonic via port openings may align to form photonic via ports that extend fully through the chip stack 100 or partially through the chip stack 100. Thus, not all PICs of the chip stack 100 need have openings contributing to a photonic via port. For example, FIG. 2C illustrates an example where the bottommost PIC PIC1 of chip stack 100 does not include a photonic via port opening. As another example, a topmost PIC or an intermediate PIC may not include photonic via port openings to assist in forming a photonic via port (e.g., they may instead “cap off” some or all of the photonic via ports formed in the chip stack 100).

From a top down perspective, the photonic via port openings may be in the form of a square or rectangle or take some other geometric shape. As shown in FIG. 1 (right side), the photonic via port openings formed in PICs that form a photonic via port may be geometrically similar (in view of their shape from a top down view). The photonic via port openings may have the same size or have different sizes. For example, as shown in the examples of FIGS. 1, 2A, 2B and 2C, with respect to a single photonic via port, the photonic via port openings in PICs are progressively larger in each PIC from bottom to top in the chip stack 100, thereby exposing part of the top surface of the PICs within the photonic via port to allow vertical optical connections (e.g., optical waveguides having a PWB cores) to surface couplers at these exposed top surfaces of the PICs. For example, a vertical cross sectional view of the chip stack 100 taken through a photonic via port may include a stair-step profile of the chip stack within the photonic via port (e.g., each side of the photonic via port may be formed in a stair-step fashion, such as shown in FIGS. 1, 2A and 2B.

In step (b), vertical optical interconnections are formed. Each vertical optical interconnection is formed to connect (contact) an optical coupler of PIC1 at one end and an optical coupler of PIC2 at its other end. The optical couplers may be a surface coupler at an exposed top surface of the PICs or an edge coupler at a side surface of the PICs as describe herein. The PWBs may be formed at the outer boundaries of the PICs (e.g., as highlighted in FIG. 1, left side) and within each of the photonic via ports formed by the openings of the PICs (e.g., as highlighted in FIG. 1, right side). Details of the option for such connections between the PICs have been described elsewhere herein and need not be repeated.

These vertical optical interconnections may be formed of a polymer material, and may be a PWB formed by a 3D polymerization process (e.g., by direct laser writing (DLW), one-photon or two-photon polymerization, or other similar additive fabrication methods) described elsewhere herein. For example, the chip stack may be immersed in a liquid photosensitive polymer resist and the PWBs maybe formed using DLW as described elsewhere herein. After formation of the PWBs, the remaining liquid photosensitive polymer resist may be removed with a chemical developer, leaving the solidified, free-standing PWBs.

The pitch of PWB waveguides (and spacing between adjacent PWBs) is often limited by the development process where liquid surface tension may cause a collapse of the densely packaged polymer PWB waveguides. In some examples, a critical-point-drying developing process may be implemented, where the liquid phase solvent of the developer is directly transformed to its gas phase at the critical point condition without inducing the surface tension that leads to structure collapse of the PWB waveguides. For example, liquid carbon dioxide (CO₂) may be used as a solvent for the developer for the chemical developer (or it may be introduced to replace a different initial development solvent prior to the development drying step during). After introducing the liquid carbon dioxide (CO₂), the liquid carbon dioxide (CO₂) may be converted to a gas at its critical point by raising its temperature and pressure; it has a critical point at a temperature of 30 degrees centigrade and a pressure of 73.8 bar. Once the carbon dioxide (CO₂) passes the critical point, it exists as a supercritical fluid (resulting in no/little surface tension), and then the carbon dioxide is removed with no surface tension damage to the PWBs.

After formation of the PWBs, a cladding material (e.g., a polymer cladding) may fill the photonic via ports before the next die attaching process. The polymer cladding may protect the polymer waveguide cores (the PWBs) during the subsequent processes. The polymer cladding may be added as a liquid into the photonic via ports and cured to a hardened solidified state (e.g., by light, such as UV, or heat). The polymer cladding may be a low-index polymer, such as a UV-curable epoxy, an acrylic resin, a transparent epoxy and/or an adhesive (which may be the same adhesive as that used to bond the PICs together in some examples and thus may be applied to the photonic via ports as well as the top surface of the upper PIC). The polymer cladding should have an index of refraction less than that of the material of the PWBs (e.g., n=1.5 to 1.55). Polymer cladding is not necessary if air cladding is used (e.g., the PWBs are left free standing in the final VIPs product). Cladding material need not be added immediately after forming the corresponding PWBs (to which it will surround) and may instead be added after the entire VIPs chip stack 100 is formed (or after more than one chip has been stacked).

In step (c), PIC3 is attached to PIC2, which may be in the same manner as described with respect to PIC2 being attached to PIC1. In step (d), vertical optical interconnections are formed between PIC3 and PIC2 and/or between PIC3 and PIC1, which may be in the same manner as described with respect to step (b). Additional PICs and/or EICs may be continued to be stacked in such a manner by repeating steps (c) and (d). As exemplary details of steps (a) and (b) may be repeated in steps (c) and (d), repeating such details need not be set forth again here.

Note that the vertical optical interconnections may be formed between various PICs of the chip stack 100 and need not be formed solely between (if at all) adjacent chips of the chip stack 100. In such case, the certain photonic via port openings may be left empty of a cladding polymer and filled later. For example, to form optical interconnections from a lower PIC (e.g., PIC1) to both an intermediate PIC (e.g., PIC2) and an upper PIC (e.g., PIC 3) of the chip stack 100, the intermediate PIC PIC2 may be stacked on the lower PIC PIC1, and optical interconnections may be formed therebetween. The photonic via ports may be left unfilled and the upper PIC PIC3 may be attached to PIC2 and vertical optical interconnections may be formed between PIC3 and PIC1 (and possibly between PIC3 and PIC 2 as well, if desired). At this time, the cladding polymer may be added to the photonic via port openings to fill open areas within the photonic via port openings at the level of PIC1, PIC2 and PIC3.

The sizes and stacking formation of the chips of the chip stack 100 may vary from the example shown. Offset stacking of the PICs may result in a stair-step formation at the edges of the chip stack 100 as shown in FIG. 1. Alternatively, outer edges of the PICs may be coplanar. In some examples, with respect to a tope down view, all of the PICs stacked on the lower PIC may be formed within (or substantially within, such as having 90% or more of its footprint area formed within) the footprint of the lowermost PIC to provide a compact form factor. The term ‘footprint’ of an element may be the area of a vertical projection of the element onto a horizontal plane (or horizontal planar surface) to describe the horizontal area occupied by the element.

In some examples, rather than attaching a single PIC on the upper surface of another PIC, multiple PICs, may be attached to the upper surface of the lower PIC and form a multi-PIC layer of the chip stack 100. The PICs of the multi-chip layer may be separated from one another so that gaps are formed between adjacent ones of the PICs of this multi-PIC layer. These multiple PICs may take the place of a single PIC in the chip stack 100 and the gap(s) formed therebetween may be used to form vertical optical interconnections in the same manner as described with respect to the photonic via ports (e.g., the gaps may form photonic via ports with the photonic via port openings of the PICs on which they are stacked). Additional PICs may be stacked on this multi-PIC layer of the chip stack 100.

As described herein, with respect to a single photonic via port, photonic via port opening of an upper PIC may be formed with a larger size or be offset with respect to a photonic via port opening of a lower PIC so that the upper PIC does not overlap or contact a portion of the upper surface of the lower PIC having surface couplers formed therein. In alternative examples, a recess may be formed in the bottom surface of the upper PIC to accommodate PWB connections to surface couplers of the bottom PIC. For example, PIC 2 may be formed to have a recessed bottom surface at locations surrounding a photonic via port so that PWBs may be connected to surface couplers on the surface of PIC1 that are located under PIC2 (e.g., PIC2 and a recessed bottom surface of PIC2 vertically overlap the surface couplers of PIC1). Alternatively, spacers (which may be preformed balls or bumps, or thick “dummy” PWBs) may be formed on the upper surface of lower PICs when forming PWBs that form the vertical optical interconnects between the PICSs For example, such spacers may be formed on the top surface of PIC1 to vertically space the PIC1 and PIC2 sufficiently to prevent the bottom of the PIC2 from contacting the PWBs connecting to surface couplers attached to the top surface of PIC1 that PIC2 overlaps.

According to some examples, the process may provide optical integration and connection of PICs vertically. As such, optical channels may be formed that extend vertically and in parallel (and spaced apart horizontally) through the chip stack 100, allowing simultaneously processing of such channels with different PIC platforms in a compact form factor. In contrast, optical connections of horizontally spaced apart PIC chips result in a significantly larger form factor (larger footprint) and are often limited to providing optical connections between adjacent edges of the adjacent PICS.

In some exemplary embodiments of the VIPS, each channel may be formed with identical photonic circuitry of the different PICs that are interconnected by the vertical optical interconnections (e.g., the PWBs). For example, a 2D N×M array of identical photonic circuits (or repetitive identical cells of photonic circuits) spaced apart horizontally may form N×M channels vertically extending through the chip stack 100 (where N and M are integers). Thus, each PIC may include a 2D array of corresponding photonic circuit cells. Each optical channel may be formed by the vertically connected photonic circuit cells of each of the PICs of the chip stack 100 to form a 2D array of vertical optical channels formed with identical photonic circuit cells from each of the PICs. Each vertical channel may thus be similarly optically processed. Photonic via ports formed within the chip stack may provide high density inter-chip optical connections that need not be limited by the chip edge length; the process may provide vertical connection of devices in different chips through a photonic via port without the need of routing the device inputs/outputs to the chip edge. The process allows formation of single-mode polymer waveguides. Pitches between polymer waveguides may be made smaller by using critical-point drying in the development process. In addition, the process provides a way of continuously stacking and optically connecting multiple PIC chips.

The foregoing is illustrative of exemplary embodiments and is not to be construed as limiting thereof. Although a few exemplary embodiments have been described, those skilled in the art will readily appreciate that many modifications are possible without materially departing from the novel teachings and advantages of the inventive concepts. Accordingly, all such modifications are intended to be included within the scope of the present invention as defined in the claims.

1. A photonic integrated circuit (PIC) package, comprising:
a chip stack of PIC chips, including a first PIC chip and a second PIC chip stacked on the first PIC, wherein, with respect to a top down view, each PIC chip having an outer boundary;
a first photonic via port formed in the chip stack formed inside the outer boundary of the first PIC chip and inside the outer boundary of the second PIC chip, the via optical port being defined at least by a first opening vertically extending fully through the second PIC chip from a top surface of the second PIC chip to a bottom surface of the second PIC chip;
a plurality of polymer waveguides formed within the via optical port and within the first opening of the second PIC chip to form a plurality of vertical optical interconnections between the first PIC chip and the second PIC chip.
